(19) United States
(12) Patent Application Publication
(10) Pub. No.: US 2026/0295872 A1
(43) Pub. Date: Oct. 1, 2026

(54) MECHANICAL DEVICE

(71) Applicant: HONDA MOTOR CO., LTD., Tokyo (JP)

(72) Inventors: Tetsuya ISHIKAWA, Saitama (JP); Hokuto AIZAWA, Saitama (JP)

(21) Appl. No.: 19/547,175

(22) Filed: Feb. 23, 2026

(30) Foreign Application Priority Data
Mar. 31, 2025 (JP) 2025-058472

(51) Int. Cl. B25J 19/00; B25J 17/02

(52) U.S. Cl. CPC B25J 19/0025; B25J 17/0258

(57) ABSTRACT

Provided is a mechanical device having two members that are rotatably connected to each other via a joint. An end effector (mechanical device) comprises: a drive source (first member); a hand unit (second member) connected to the drive source via a joint capable of pivoting about a first rotational axis; and a flexible shaft (at least one cable) that is flexible and supported by the drive source and the hand unit. When a relative rotational position between the drive source and the hand unit is a middle position within a range of rotation about the first rotational axis, the flexible shaft presents an S-shape between the drive source and the hand unit as viewed along the first rotational axis.

### TECHNICAL FIELD

The present invention relates to a mechanical device, in particular to a mechanical device having a cable supported by first and second members that are rotatably connected to each other via a joint.

### BACKGROUND ART

In recent years, research and development has been conducted on robots that lead to energy efficiency, with the aim of ensuring that more people can have access to affordable, reliable, sustainable, and advanced energy.

Known configurations of such robots include an industrial robot that enables various cables such as motor power lines and encoder signal lines, to be configured so as not to interfere with rotational motions of rotating members (Patent Document 1). The industrial robot includes a fixed unit, a rotatable unit capable of rotating relative to the fixed unit, and a plurality of cables that connect the fixed unit and the rotatable unit. In the robot of the prior art, the cables are arranged uniformly or substantially uniformly about a rotational axis such that, when each of the cables is in a reference state, the radial bulge relative to the rotational axis is maximized, allowing structural components to be placed within a space around the rotation center surrounded by the plurality of cables. The maximum rotation angle and the cable length are determined to prevent the cables from interfering with the structural components even when the cables become twisted during the rotation of the rotatable unit. This feature also prevents or minimizes interference between the cables themselves.

Patent Document 2 discloses a wrist device in which piping and wiring components pass through a wrist portion of the device, where the piping and wiring components supply air, water, and electricity to work tools attached to the tip of an industrial robot. The wrist device includes an outer housing supported by an arm via a first hollow connecting member; an intermediate housing supported by the outer housing via a second hollow connecting member; and a tool support member supported by the intermediate housing via a third hollow connecting member. The piping and wiring components are arranged so as to pass through within the first hollow connecting member, the second hollow connecting member, and the third hollow connecting member.

### PRIOR ART DOCUMENT(S)

### Patent Document(s)

Patent Document 1: JP2015-033748A
Patent Document 2: JP2000-334689A

### SUMMARY OF THE INVENTION

### Task to be Accomplished by the Invention

In the above-described devices of the prior art, a first member such as a fixed unit or an arm, and a second member such as a rotatable unit and a housing are rotatably connected to each other. Thus, cables can be arranged around a rotational axis (extending in the connecting direction of a connection between two members to be connected) or such that the cables pass through the rotational axis. In this case, when the housing rotates, the cables are only twisted and are not significantly displaced.

When the first member and the second member are connected to each other to allow the first and second members to rotate about a rotational axis extending in a direction different from the connecting direction of the connection, the above-described cable wiring arrangement, in which the cables extend along the rotational axis, cannot be applied. When the number of cables is small, the cables can be arranged to intersect with the rotational axis. Thus, when the first and second members are rotated about the rotational axis, the cables are only deformed to be curved or extended and are not significantly displaced.

However, in some cases, such as when the number of cables is large, the cables cannot be arranged so that the cables intersect with the rotational axis. In such cases, when the two members rotate about the rotational axis, the cables are curved or extended to be significantly displaced. As a result, the cables come into contact with other nearby components, which creates resistance to relative rotational motions of the two members. This results in the reduced efficiency of energy consumption of the device.

The present invention has been made in view of the problem of the prior art, and a primary object of the present invention is to provide a mechanical device having two members that are rotatably connected to each other via a joint and configured to enable one or more cables to be placed so as not to hinder relative rotation of the two members. This configuration further assists the improvement of efficiency of energy consumption of the device.

### Means to Accomplish the Task

As a solution to the above-described task to be accomplished, an aspect of the present invention provides s mechanical device comprising: a first member; a second member connected to the first member via a joint capable of pivoting about a first rotational axis; and at least one cable that is flexible and supported by the first member and the second member, wherein, when a relative rotational position between the first member and the second member is a middle position within a range of rotation about the first rotational axis, the at least one cable presents an S-shape between the first member and the second member as viewed along the first rotational axis.

### Effect of the Invention

The above-described configuration enables cables to be placed so as not to hinder relative rotation of the two members of the mechanical device.

### BRIEF DESCRIPTION OF THE DRAWINGS

FIG. 1 is a perspective view showing an important part of an end effector;

FIG. 2 is a longitudinal sectional view of a base end part of a shaft unit;

FIG. 3 is a perspective view of a connecting arrangement of the shaft unit;

FIGS. 4A and 4B are explanatory diagrams of the connecting arrangement of the shaft unit;

FIGS. 5A to 5C are explanatory diagrams showing operations of the connecting arrangement of the shaft unit;

FIGS. 6A to 6C are explanatory diagrams showing operations of a connecting arrangement of a shaft unit of a comparative example;

FIG. 7 is a perspective view of the important part of the end effector viewed from an angle different from that of FIG. 1; and

FIG. 8 is a perspective view of an important part of an end effector of a comparative example, which corresponds to the part shown in FIG. 7.

### DESCRIPTION OF THE PREFERRED EMBODIMENT(S)

Embodiments of an end effector 1 according to one embodiment of the present invention will be described with reference to the appended drawings.

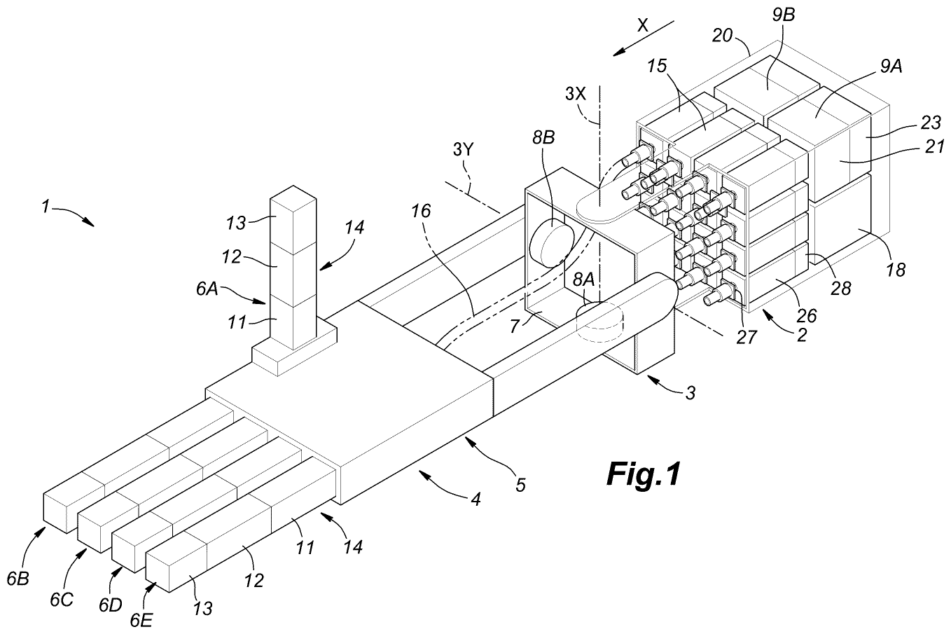

The end effector 1 is a multi-joint arm equipped with a hand having multiple degrees of freedom, and what is called a human-type robot (humanoid robot) that forms a human arm portion from the forearm to the fingertips. FIG. 1 is a perspective view showing an important part of the end effector. However, FIG. 1 shows only an exemplary configuration, and embodiments of the present invention are not limited to this configuration.

As shown in FIG. 1, the end effector 1 includes a drive source 2 corresponding to the forearm and a hand unit 4 connected to the drive source 2 via a wrist joint 3. The drive source 2 is supported at its base end side by an upper arm portion (not shown) via an elbow joint. The hand unit 4 is provided at a position on an extension of the drive source 2 on the tip side. Hereinafter, the tip end side of the drive source 2 is also referred to as “front”, and the base end side as “rear”. The hand unit 4 includes a palm portion 5 connected to the drive source 2 via the wrist joint 3, and a plurality of finger portions 6 (6A to 6E) movably supported by palm portion 5. As used herein, the term “finger portion” refers to a finger or thumb of a hand, and the term “fingertip” refers to the distal end of a finger or thumb of a hand.) The palm portion 5 corresponds to a human palm, and the finger portions 6 correspond to human fingers and thumb.

The hand unit 4 of the present embodiment includes five finger portions 6; that is, a first finger portion 6A, a second finger portion 6B, a third finger portion 6C, a fourth finger portion 6D, and a fifth finger portion 6E. As used herein, when referring to the first to fifth finger portions collectively or without distinguishing among them, this element(s) is also referred to simply as “finger portion 6.” The first finger portion 6A corresponds to a thumb, the second finger portion 6B corresponds to an index finger, the third finger portion 6C corresponds to a middle finger, the fourth finger portion 6D corresponds to a ring finger, and the fifth finger portion 6E corresponds to a little finger.

The wrist joint 3 has a connection member 7 that links the drive source 2 and the hand unit 4. The connection member 7 is connected to the drive source 2 such that the connection member 7 is rotatable about a first rotational axis 3X extending in a direction different from the direction of the extension of the drive source 2 (hereinafter also referred to as “X-direction”). The connection member 7 is also connected to the hand unit 4 such that the connection member 7 is rotatable about a second rotational axis 3Y extending in a direction different from both the X-direction and the first rotational axis 3X. This configuration allows the hand unit 4 to rotate about both the first rotational axis 3X and the second rotational axis 3Y. In the present embodiment, the first rotational axis 3X is at a right angle to the X direction, and the second rotational axis 3Y is at a right angle to the first rotational axis 3X. Thus, the second rotational axis 3Y may be at a right angle to the X direction. In the present embodiment, the first rotational axis 3X and the second rotational axis 3Y intersect with (i.e., are perpendicular to) each other.

The connection member 7 is connected to the drive source 2 via a first reducer 8A, which is a rotational device provided to be rotatable about the first rotational axis 3X. The palm portion 5 is connected to the drive source 2 via a second reducer 8B, which is a rotational device provided to be rotatable about the second rotational axis 3Y. The first reducer 8A is a drive mechanism that drives the connection member 7 relative to the drive source 2, and the second reducer 8B is a drive mechanism that drives the palm portion 5 relative to the connection member 7. The two reducers 8 (8A, 8B) form palm portion drive mechanisms that allow for rotation of the palm portion 5 of the hand unit 4 relative to the drive source 2 about the first rotational axis 3X and the second rotational axis 3Y.

The connection member 7 is driven by a first palm portion drive source 9A via the first reducer 8A. The palm portion 5 is driven by a second palm portion drive source 9B via the second reducer 8B. The two palm portion drive sources 9 (9A, 9B) are the drive sources that drive the palm portion 5 relative to the drive source 2. Each of the palm portion drive sources 9 is provided on the drive source 2 and transmits a palm portion drive force to a rotatable shaft portion of the palm portion 5 via a palm portion drive transmission mechanism (not shown).

Each finger portion 6 includes a first link 11, a second link 12, and a third link 13 connected in series to the palm portion 5, and a corresponding finger portion drive mechanism 14 that drives the first link 11, the second link 12, and the third link 13. Each of the finger portion drive mechanisms 14 is provided on the palm portion 5 and the corresponding finger portion 6. Provided on the palm side of the palm portion 5 and on the first finger portion 6A is the corresponding finger portion drive mechanism 14 for driving the first finger portion 6A. The four finger portion drive mechanisms 14 for driving the second finger portion 6B, third finger portion 6C, fourth finger portion 6D, and fifth finger portion 6E are provided on the back side of the palm portion 5 and on the corresponding finger portions 6.

Each finger portion 6 is driven by a plurality of finger portion drive sources 15 via the corresponding finger portion drive mechanism 14. Each finger portion drive source 15 is a drive source that drives the corresponding finger portion 6 relative to the palm portion 5. Each finger portion drive source 15 is mounted on the drive source 2 and transmits a finger portion drive force to the corresponding finger portion 6 via a finger portion drive transmission mechanism 16 as described later. In the present embodiment, the sixteen finger portion drive sources 15 are mounted on the drive source 2.

The drive source 2 includes a control device 18 for controlling the operations of the palm portion drive sources 9 and finger portion drive sources 15. The control device 18 is positioned to align with the two palm portion drive sources 9 (9A, 9B) in the vertical direction.

The drive source 2 has a generally square cross-sectional shape and includes a drive source casing 20 that defines an internal space for accommodating the palm portion drive sources 9, the finger portion drive sources 15, and the control device 18. Each palm portion drive source 9 is a large electric motor that outputs relatively high torque, while each finger portion drive source 15 is a small electric motor that outputs relatively low torque.

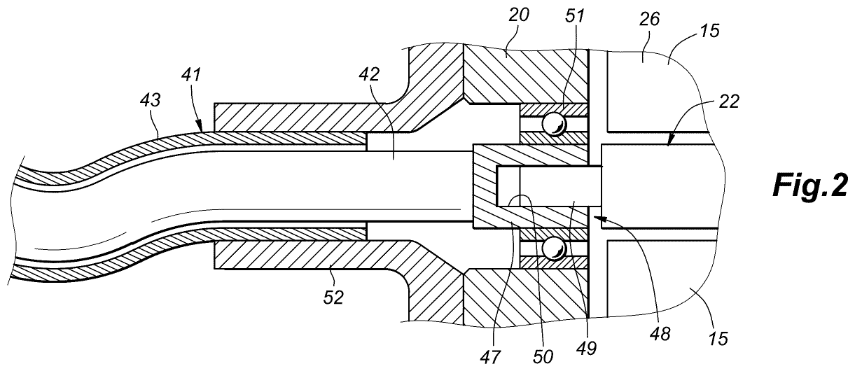

Each of the palm portion drive sources 9 includes: a motor body 21 having a short cylindrical shape with a relatively large diameter as viewed along the axial direction; an output shaft 22 (FIG. 2) that outputs a driving torque of the motor body 21; and a motor driver 23 that drives the motor body 21. The motor body 21 is provided on a relatively rear part of the drive source 2; that is, on a portion distant rearward from the wrist joint 3, in such a posture that the output shaft 22 faces frontward (toward the tip of the drive source 2). The motor driver 23 has a shape that is nearly square as viewed along the output shaft axis and is integrally formed at the rear end of the motor body 21.

Each of the finger portion drive sources 15 includes: a motor body 26 having a long cylindrical shape with a relatively small diameter along the axial direction; an out put shaft 27 that outputs a driving torque of the motor body 26; and a motor driver 28 that drives the motor body 26. The motor body 26 is mounted on a front part of the corresponding palm portion drive source 9 within the drive source 2, in such a posture that the output shaft 27 faces frontward. The motor driver 28 has a shape that is nearly square as viewed long the direction of the output shaft 27 and is integrally formed at the rear end of the motor body 26.

The output shaft 27 of each finger portion drive source 15 protrudes slightly from the front surface of the motor body 26, and its distal end (output end) is located near the front surface of the motor body 26 of the finger portion drive source 15. The output shaft 22 of each palm portion drive source 9 protrudes significantly from the front surface of the motor body 21 and is positioned to pass through the gap of the finger portion drive source 15. The distal end (output end) of the output shaft 22 of each palm portion drive source 9 is located at the same position as the distal end of the finger portion drive source 1; that is, near the front surface of the motor body 26 of the corresponding finger portion drive source 15.

The sixteen finger portion drive sources 15 are arranged in four rows in the direction along the first rotational axis 3X and four rows in the direction along the second rotational axis 3Y. These finger portion drive sources 15 are arranged with gaps in both the directions of the first rotational axis 3X and the second rotational axis 3Y. The expression “with gaps” means that gaps are formed between the motor drivers 28 having the largest cross-sectional dimensions of any two adjacent finger portion drive sources 15.

The output shaft 22 of each palm portion drive source 9 is connected to the corresponding reducer 8 of the connection member 7 such that the output shaft 22 can transmit power via a palm portion drive transmission mechanism (not shown). In the present embodiment, the palm portion drive transmission mechanism is formed by a shaft unit 41 (See FIG. 2) described later. Similarly, the output shaft 27 of each finger portion drive source 15 is connected to the corresponding finger portion drive mechanism 14 of the palm portion 5 such that the output shaft 27 can transmit power via the finger portion drive transmission mechanism 16, which is formed by the shaft unit 41 (see FIG. 2).

FIG. 2 is a longitudinal sectional view of a base end part of a shaft unit 41. As shown in FIG. 2, the shaft unit 41 includes a flexible shaft 42 and an outer tube 43 that covers the flexible shaft 42. Each of the flexible shafts 42 has flexibility and is capable of bending deformation. Each of the flexible shafts 42 is produced by arranging several element wires composed of steel rod (wire) or any other suitable wire rod in a strip-like manner on a single bendable core wire (core rod), and winding them in a direction forming a predetermined pitch angle relative to the axis to form a first winding layer, and then repeating the similar process, i.e., arranging several element wires in a strip-like manner and winding them in the opposite direction to the previous layer to thereby form subsequent winding layers (i.e., second and third winding layers).

Each outer tube 43 is formed as a cylindrical member with an inner bore through which the flexible shaft 42 is inserted. The outer tube 43 is formed from a plastic member or any suitable material, and similarly to the flexible shaft 42, is capable of bending deformation. The flexible shaft 42 is slidably inserted into the inner hole of the outer tube 43. Preferably, grease is injected into the interior of the outer tube 43 as a lubricant. The outer tube 43 protects the flexible shaft 42 from dust and moisture, while preventing the flexible shaft 42 from coming into contact with other components.

The outer tube 43 is formed of a porous material. Thus, the grease contained inside seeps out to the outer surface of the outer tube 43, which allows the outer tube 43 to slide with little resistance when the outer tube comes into contact and slides with other external components.

A base end and a terminal end of each flexible shaft 42 are provided with connecting members 47, which connect to the output shaft 22, 27 of the palm portion drive source 9 or finger portion drive source 15, and the finger portion drive mechanism 14. Each of the connecting members 47 forms a first connection mechanisms 48 for the output shaft 22 or 27 of a corresponding one of the palm portion drive source 9 and finger portion drive source 15.

More specifically, the output ends of the output shafts 22 and 27 of the palm portion drive source 9 and the finger portion drive source 15 each have an engagement protrusion 49, which has a plate shape (flathead screwdriver shape) and extends radially through the center of the shaft. The connecting member 47 provided at the base end of the flexible shaft 42 has an engagement groove 50 capable of receiving the engagement protrusion 49. These elements form the first connection mechanism 48.

With the engagement protrusion 49 positioned at a rotational angle corresponding to the engagement groove 50, sliding the flexible shaft 42 toward the output shaft 22 or 27 causes the engagement protrusion 49 to be inserted into the engagement groove 50. This enables the flexible shaft 42 and the corresponding one of the output shafts 22 and 27 to be interconnected via the first connection mechanism 48 for power transmission.

Generally, when the number of the palm portion drive sources 9 and finger portion drive sources 15 is large, the number of flexible shafts 42 to be connected to the output shafts 22 and 27 also increases, which prolongs a time required for assembly of the end effector 1. In the present embodiment, since the first connection mechanism 48 is adopted, only by inserting the flexible shaft 42 to the corresponding output shaft 22 or 27 of the palm portion drive source 9 or finger portion drive source 15, the connection therebetween can be made. This shortens a time required for assembly of the end effector 1.

The connecting member 47 of the flexible shaft 42 is rotatably supported via a bearing 51 mounted on the drive source casing 20 of the drive source 2. The outer tube 43 is movably supported by a retaining member 52 mounted on the drive source casing 20 to be slidable along its extending direction and rotatable.

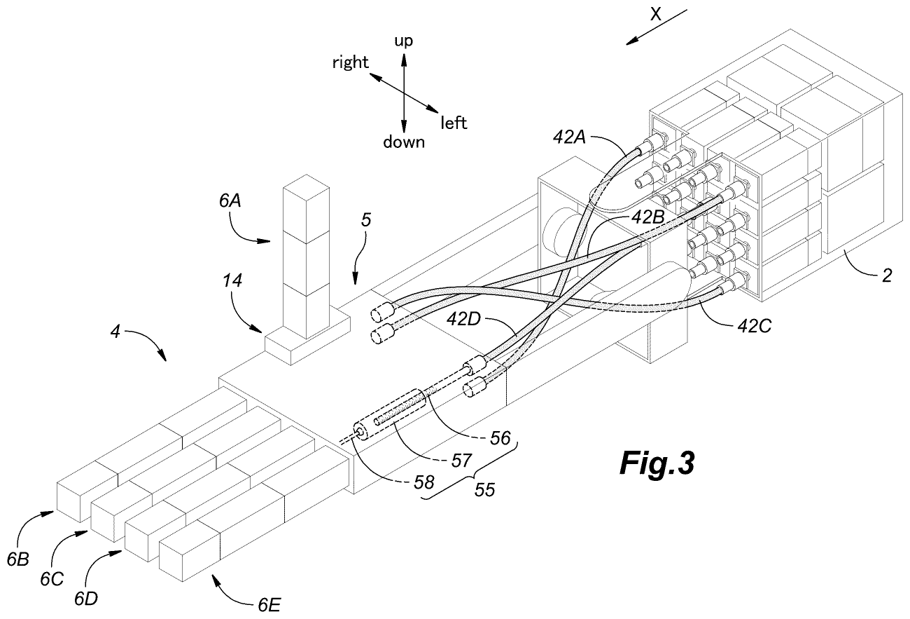

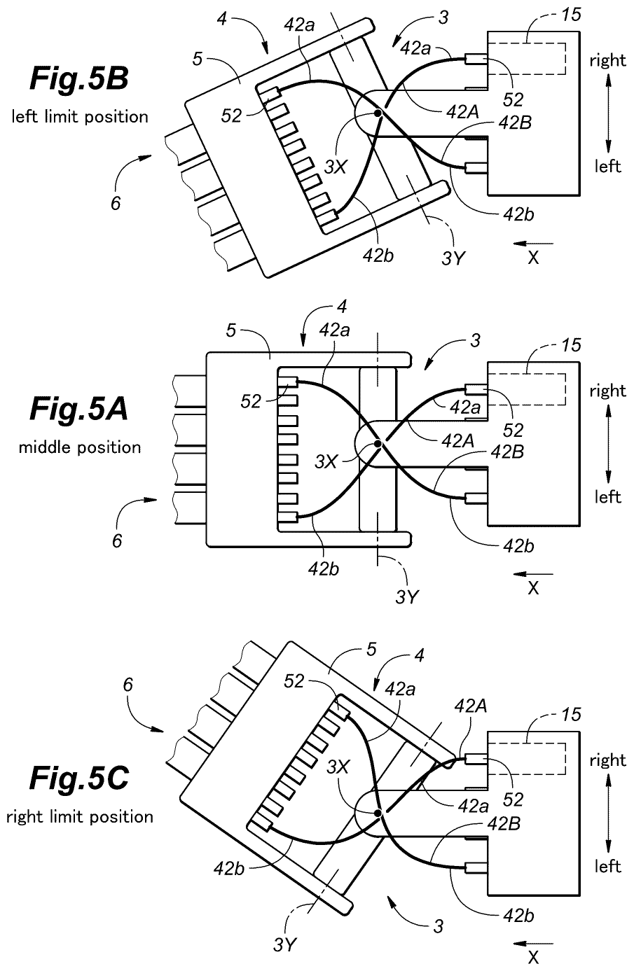

Each finger portion drive mechanism 14 has a plurality of feed screw mechanisms 55 (see FIG. 3) to drive the corresponding finger portion 6 having four degrees of freedom. As shown in FIG. 3, each feed screw mechanism 55 includes a screw shaft 56 to which the end of the flexible shaft 42 is connected, a slider 57 equipped with a female thread that mates with the male thread of the screw shaft 56, and a rod 58 connected to the slider 57. The flexible shaft 42 is connected to one end of the screw shaft 56 via an insert type connection mechanism, which is similar to that shown in FIG. 2. A retaining member 52 (FIGS. 2 and 5) is mounted on a portion of the feed screw mechanism 55 to which the flexible shaft 42 is connected, and the outer tube 43 is held by the retaining member 52 so that the outer tube 43 can slide in its extension direction and rotate

Torque transmitted from the flexible shaft 42 to the screw shaft 56 of the feed screw mechanism 55 is converted into linear motion of the slider 57, driving the finger portion drive mechanism 14 via the rod 58. A plurality of feed screw mechanisms 55 are provided for each finger portion drive mechanism 14. Each feed screw mechanism 55 in combination with a corresponding shaft unit 41 forms the corresponding finger portion drive transmission mechanism 16 of the finger portion drive source 15.

A plurality of actuators are formed by the corresponding plurality of finger portion drive sources 15, shaft units 41, and feed screw mechanisms 55. Each feed screw mechanism 55 forms the output part of a corresponding actuator. Any of the finger portions 6 may be driven with four degrees of freedom by, for example, a set of four actuators via the corresponding finger portion drive mechanism 14.

Next, a connecting arrangement of the flexible shaft 42 will be described with reference to FIGS. 3 to 6. FIG. 3 is a perspective view of a connecting arrangement of the flexible shafts 42. FIG. 3 shows only the four flexible shafts 42 connected to the four finger portion drive sources 15 positioned at the four corners of the rectangular drive source 2, and does not show the other twelve flexible shafts 42 for illustrative purposes. In the following description, the directions represented by the terms “up”, “down”, “left”, and “right” are defined as those indicated by arrows in FIG. 3.

As shown in FIG. 3, the finger portion drive source 15 positioned at the upper right is connected to the feed screw mechanism 55 at the lower left via the flexible shaft 42 (hereinafter referred to as a first shaft 42A). The finger portion drive source 15 positioned at the top left is connected to the feed screw mechanism 55 at the bottom right via another flexible shaft 42 (hereinafter referred to as a second shaft 42B). The finger portion drive source 15 positioned at the bottom left is connected to the feed screw mechanism 55 at the top right via yet another flexible shaft 42 (hereinafter referred to as a third shaft 42C). The finger portion drive source 15 positioned at the bottom right is connected to the feed screw mechanism 55 at the top left via yet another flexible shaft 42 (hereinafter referred to as a fourth shaft 42D). The flexible shafts 42 are connected so as to achieve this arrangement. Specifically, the flexible shafts 42 are connected between the drive source 2 and the hand unit 4 such that the flexible shafts 42 are arranged in a skew positional relationship with each other; that is, the flexible shafts 42 are not parallel to and do not intersect with each other therebetween. Thus, each flexible shaft 42 is arranged to present an S-shape. As used herein, the term “S-shape” refers to a configuration where two C-shapes with opposite bending directions are connected to each other. As used herein, the term “S-shape” includes an inverted S-shape.

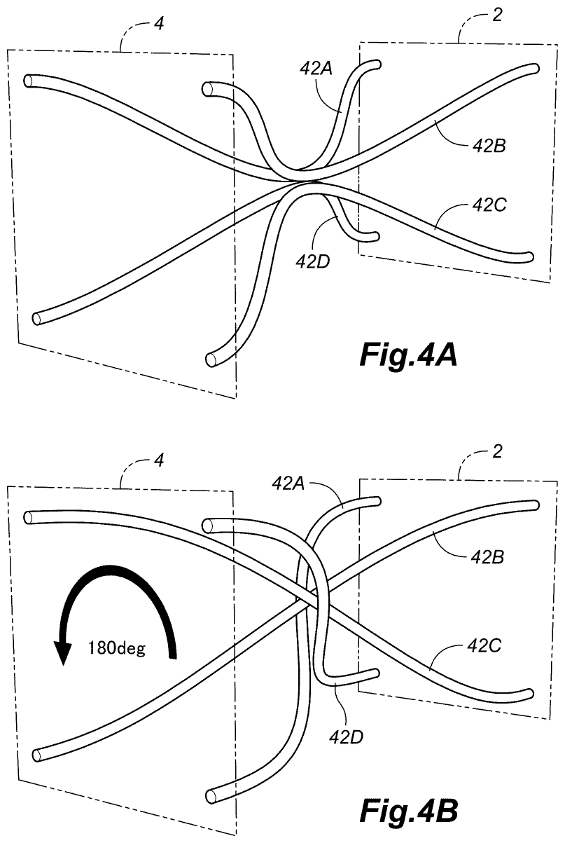

FIGS. 4A and 4B are explanatory diagrams showing the connecting arrangement of the flexible shafts 42. FIG. 4A shows the connecting arrangement before the flexible shafts 42 are twisted so as to achieve a skew positional relationship with each other, while FIG. 4B shows the connecting arrangement after the flexible shafts 42 are twisted so as to achieve a skew positional relationship with each other.

In FIG. 4A, the first shaft 42A connects the finger portion drive source 15 positioned at the upper right to the feed screw mechanism 55 positioned at the upper right. The second shaft 42B connects the finger portion drive source 15 positioned at the upper left to the feed screw mechanism 55 positioned at the upper left. The third shaft 42C connects the finger portion drive source 15 positioned at the bottom right to the feed screw mechanism 55 positioned at the bottom right. The fourth shaft 42D connects the finger portion drive source 15 positioned at the bottom right to the feed screw mechanism 55 positioned at the bottom right.

In FIG. 4B, the connecting arrangement of the plurality of flexible shafts 42 is the same as that achieved by rotating the hand unit 4 180° relative to the drive source 2 from the state shown in FIG. 4A. The expression “the connecting arrangement achieved by 180° rotation” does not mean the arrangement that is formed only by actually rotating the hand unit 4 with the connected flexible shafts 42, but rather means the same connecting arrangement formed by any possible process. This connecting arrangement of the flexible shafts 42 reduces the rotational resistance that occurs when the drive source 2 and hand unit 4 rotate about the first rotational axis 3X and the second rotational axis 3Y. The details of this configuration and its effect will be described below.

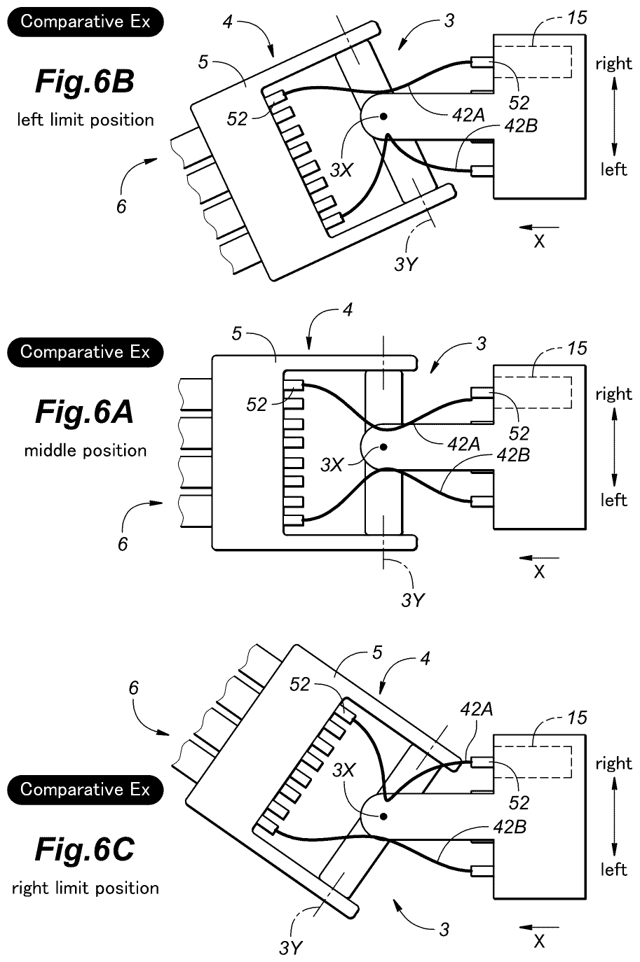

FIGS. 5A to 5C are explanatory diagrams showing operations of the connecting arrangement of the flexible shafts 42, and FIGS. 6A to 6C are explanatory diagrams showing operations of a connecting arrangement of the flexible shafts 42 of a comparative example. The operations of the connecting arrangement will be described below with reference to an example where the hand unit 4 rotates about the first rotational axis 3X relative to the drive source 2. However, when the hand unit 4 rotates about the second rotational axis 3Y, the connecting arrangement is similarly operated. FIGS. 5A and 6A show a state where the hand unit 4 is at a middle position within a range of rotation relative to the drive source 2. FIGS. 5B and 6B show a state where the hand unit 4 is at a left limit position of the range of rotation relative to the drive source 2. FIGS. 5C and 6C show a state where the hand unit 4 is at a right limit position of the range of rotation relative to the drive source 2. In these figures, only the palm portion 5 of the hand unit 4 is shown and the finger portions 6 are not shown.

First, the connecting arrangement of the flexible shafts 42 according to the comparative example will be described with reference to FIGS. 6A to 6C. The description about the connection positions and rotational directions of the hand unit 4 will be based on the left and right directions shown in FIG. 3.

As shown in FIG. 6A, in the comparative example, the flexible shaft 42 connects connecting positions of the drive source 2 to corresponding positions of the hand unit 4. Two of the flexible shafts 42 (42A, 42B) will be described first. The first shaft 42A connects the finger portion drive source 15 positioned at the upper right to the upper right feed screw mechanism 55 (FIG. 3). The second shaft 42B connects the finger portion drive source 15 positioned at the upper left to the upper left feed screw mechanism 55. When the hand unit 4 is in the middle position, the two flexible shafts 42 (42A, 42B) have a length allowing slack to the extent that allows the hand unit 4 to rotate. A middle part of each flexible shaft 42 extends to pass near the first rotational axis 3X.

As shown in FIG. 6B, when the hand unit 4 rotates to the left limit position, the slack in the first shaft 42A becomes smaller; that is, the first shaft 42A deforms to become extended. Thus, the middle part of the first shaft 42A moves away from the first rotational axis 3X. Meanwhile, the slack in the second shaft 42B increases; that is, the first shaft 42A deforms to become bent. Thus, the middle part of the second shaft 42B moves close to the first rotational axis 3X, moves beyond the first rotational axis 3X, or twists to form a loop.

As shown in FIG. 6C, when the hand unit 4 rotates to the right limit position, the first shaft 42A and the second shaft 42B move in the opposite direction to when the hand unit 4 rotates to the left limit position.

Thus, in either case where the hand unit 4 rotates to the left or right, the two flexible shafts 42 (42A, 42B) deform to become extended or bent, causing significant displacement in their longitudinal middle parts. Thus, the deformation of the flexible shafts 42 creates rotational resistance of the hand unit 4. In some cases, the flexible shafts 42 may come into contact with other components, such as another flexible shaft 42 or the connection member 7, which also results in the additional rotational resistance of the hand unit 4.

Conversely, the connecting arrangement of the flexible shaft 42 of the present embodiment results in a lower rotational resistance. The connecting arrangement of the flexible shafts 42 of the present embodiment will be described with reference to two flexible shafts 42 (42A, 42B) in FIG. 5, similarly to the comparative example.

As shown in FIG. 5A, the first shaft 42A connects the finger portion drive source 15 positioned at the upper right to the feed screw mechanism 55 positioned at the lower left (FIG. 3). The second shaft 42B connects the finger portion drive source 15 positioned at the lower left to the feed screw mechanism 55 positioned at the upper right.

Thus, in the axial view of the first rotational axis 3X (FIG. 5), both of the flexible shafts 42 exhibit an S-shape (one being an S-shape and the other an inverted S-shape). The axial view of the first rotational axis 3X refers to the viewpoint seen along the first rotational axis 3X, and the first rotational axis 3X extends in the direction perpendicular to the plane of FIG. 5. More specifically, the first shaft 42A includes a first section 42a on the side of the drive source 2 having a curve whose direction of curvature is a first direction, and a second section 42b on the side of the hand unit 4 having a curve whose direction of curvature is a second direction opposite to the first direction. On the other hand, the second shaft 42B includes a first section 42a on the hand unit 4 having a curve whose direction of curvature is the first direction, and a second section 42b on the side of the drive source 2 having a curve whose direction of curvature is the second direction.

In other words, when the hand unit 4 is in the middle position, each of the two flexible shafts 42 has a length that allows slack so that the hand unit 4 can rotate. The middle part of each flexible shaft 42 extends to pass near the first rotational axis 3X. The middle part of each flexible shaft 42 is preferably located so as to intersect with the first rotational axis 3X.

As shown in FIG. 5B, when the hand unit 4 rotates to the left limit position, the first shaft 42A deforms such that the length of the first section 42a becomes shorter and the length of the second section 42b becomes longer. Meanwhile, the second shaft 42B deforms such that the length of the first section 42a becomes longer and the length of the second section 42b becomes shorter. Both the first shaft 42A and the second shaft 42B do not deform in a manner that significantly changes their curvature. Thus, the amount of displacement of the position of the middle part of each flexible shaft 42 relative to the first rotational axis 3X is smaller compared to that in the comparative example.

As shown in FIG. 5C, when the hand unit 4 rotates to the right limit position, the first shaft 42A and the second shaft 42B move (deform) in the opposite direction to when the shafts rotate to the left limit position. Similarly to the case of the left limit position, the deformation of each flexible shaft 42 is small, and the amount of displacement of the position of the middle part of each flexible shaft 42 relative to the first rotational axis 3X is small.

Thus, in either case where the hand unit 4 rotates to the left limit position or the right limit position, the first shaft 42A and the second shaft 42B deform to shift their inflection points, while avoiding each shaft from deforming so as to significantly change the curvature or cause large displacement of the longitudinal middle part of the shaft. This prevents the flexible shafts 42 from deforming to cause resistance to the relative rotational motions of the hand unit 4 and the drive source 2, and from coming into contact with other components such as other flexible shafts 42 or the connection member 7, thereby suppressing the increase in the resistance to the rotational motions of the hand unit 4 relative to the drive source 2.

In particular, in the present embodiment, each flexible shaft 42 is used as a cable to transmit torque. Thus, a state in which the flexible shaft 42, while rotating to transmit torque, comes into contact with other members hinders the rotation of the flexible shaft 42 resulting in a change in the torque transmitted by the flexible shaft 42. In the present embodiment, since the flexible shaft 42 is housed in the outer tube 43 into which grease has been injected, the flexible shaft 42 can rotate with low resistance inside the outer tube 43 and efficiently transmit torque.

Referring to FIG. 5, the operation and effect of each flexible shaft 42 has been described with reference to the configuration as viewed along the first rotational axis 3X. However, in the case of a configuration as viewed along the second rotational axis 3Y, the flexible shaft 42 operates in the same manner and produces the same effect as the case of the axial view of the first rotational axis 3X.

Since the flexible shafts 42 are connected between the drive source 2 and the hand unit 4 such that the flexible shafts 42 are arranged in a skew positional relationship with each other therebetween, each flexible shaft 42 is arranged to present an S-shape in both the axial views of the first rotational axis 3X and the second rotational axis 3Y. This facilitates placement of the cables.

The connecting arrangement of the flexible shafts 42 connecting to the second, third, and fourth finger portion 6B, 6C, and 6D has been described. Next, the connecting arrangement of the flexible shafts 42 connecting to the first finger portion 6A will be described.

First, the configuration of the first finger portion 6A will be described with reference to FIG. 3. The following description is about the hand unit 4 in the middle position. As shown in FIG. 3, the first finger portion 6A is attached to the palm portion 5 in a different manner from the other finger portions 6 (6B, 6C, 6D). Specifically, the second finger portion 6B, third finger portion 6C, fourth finger portion 6D extend out in the X direction from the distal end of the palm portion 5 (the X-direction tip). Thus, the finger portion drive mechanisms 14 that drive them are arranged parallel to each other in the X direction on the distal end side of the palm portion 5.

The first finger portion 6A extends upward from a position at the middle part in the X direction and right edge of the palm portion 5. Thus, the finger portion drive mechanism 14 therefor is positioned at the position at the middle part in the X direction and right edge of the palm portion 5.

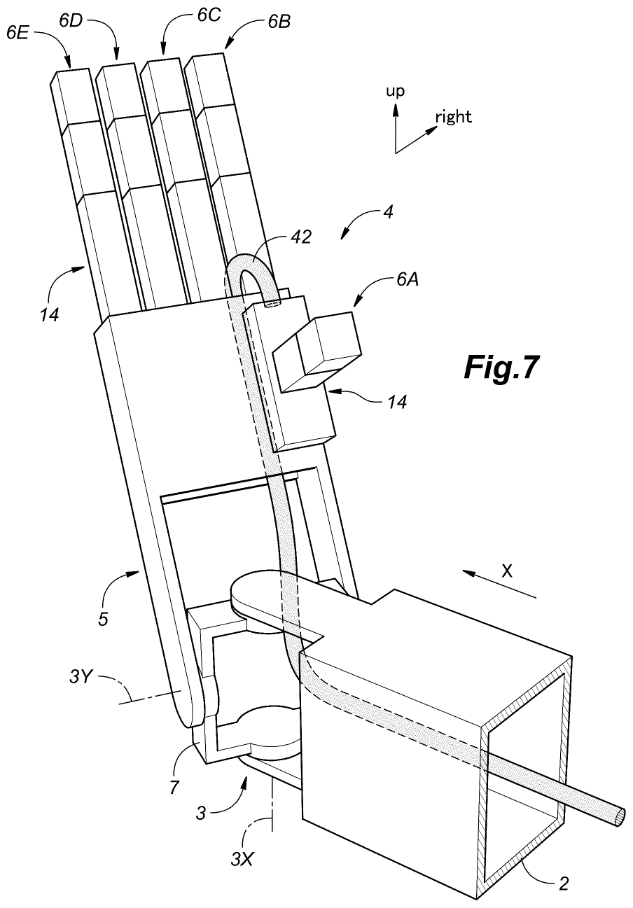

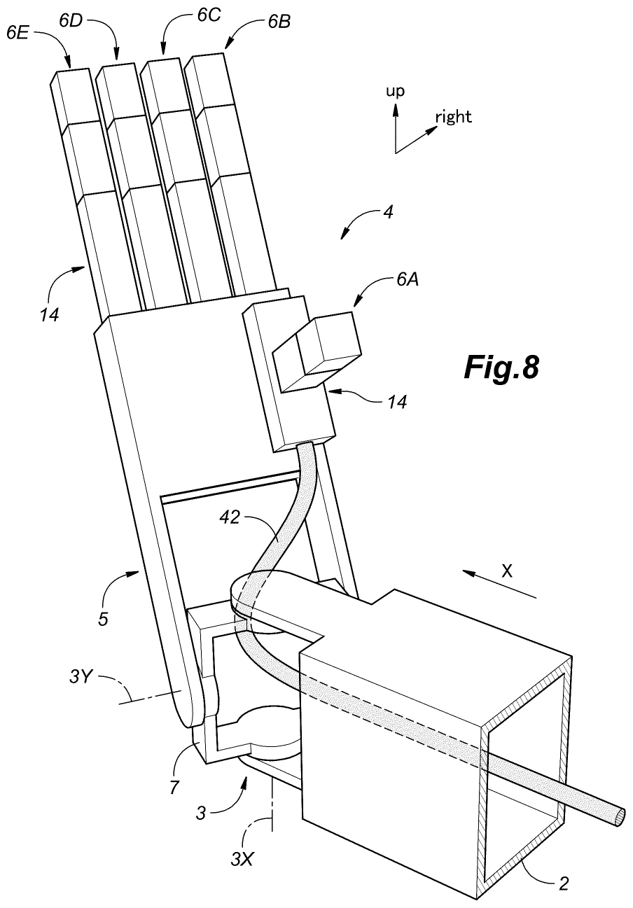

Next, the connecting arrangement of the flexible shafts 42 connecting to the first finger portion 6A will be described with reference to FIGS. 7 and 8. FIG. 7 is a perspective view of the important part of the end effector 1 viewed from an angle different from that of FIG. 1. FIG. 8 is a perspective view of an important part of an end effector 1 of the comparative example, which corresponds to the part shown in FIG. 7.

First, the connecting arrangement of one of the flexible shafts 42 of the comparative example with reference to FIG. 8. In the comparative example, the flexible shafts 42 are connected to the finger portion drive mechanism 14 of the first finger portion 6A on the side of the drive source 2 along the X direction.

When the hand unit 4 rotates upward (toward the side of the first finger portion 6A) about the second rotational axis 3Y, the flexible shaft 42 deforms into a Z-shape, increasing the curvature at the maximum curvature section. Thus, the deformation of the flexible shaft 42 creates rotational resistance, decreasing the power transmission efficiency of the flexible shaft 42. Furthermore, in order to enable the hand unit 4 to rotate about the second rotational axis 3Y, the length of the flexible shaft 42 needs to be set long enough to provide substantial slack when the hand unit 4 is in the middle position. This also applies to when the hand unit 4 rotates leftward (toward the first finger portion 6A) about the first rotational axis 3X.

In contrast, in the present embodiment shown in FIG. 7, a plurality of flexible shafts 42 are connected to the finger portion drive mechanism 14 of the first finger portion 6A from the side of the drive source 2. Specifically, the flexible shafts 42 extend to pass through the interior of the connection member 7 of the wrist joint 3, and then extending on the back side of the palm portion 5. More specifically, the flexible shafts 42 are routed to pass a space between the two adjacent finger portion drive mechanisms 14 that drive the second finger portion 6B and the third finger portion 6C. This routing arrangement prevents the flexible shafts 42 from protruding outward beyond the second finger portion 6B and the third finger portion 6C as the flexible shafts 42 pass through the palm portion 5.

The flexible shafts 42 then extend to make a U-turn around the distal end of the palm portion 5 and connect to the side of the distal end of the finger portion drive mechanism 14 provided on the palm side of the palm portion 5. In other words, the flexible shafts 42 connect to the side of the finger portion drive mechanism 14 opposite to the wrist joint 3.

Thus, when the hand unit 4 rotates toward the first finger portion 6A about the second rotational axis 3Y or the first rotational axis 3X, the flexible shafts 42 deform slightly, bending in one straight part of the U shape at an angle corresponding to the rotation angle. The maximum curvature section of each flexible shaft 42 is the U-shaped turn section, and the curvature at this section remains unchanged. This reduces the power transmission efficiency of the flexible shafts 42. Furthermore, since the flexible shafts 42 pass through the wrist joint 3, the required length of the flexible shafts 42 does not change even when the hand unit 4 rotates about the second rotational axis 3Y or the first rotational axis 3X. Thus, there is no need to set the length of the flexible shafts 42 to allow a large amount of slack to occur.

The flexible shafts 42 are thus arranged to pass through the back side of the palm portion 5, forming a U-shaped curve between the connection to the finger portion drive mechanism 14 and the portion extending along the back side of the palm portion 5. As a result, the length of the flexible shafts 42 extending on the palm side of the palm portion 5 becomes shorter thereby preventing the flexible shafts 42 from interfering with the motion of the hand unit 4.

The present invention has been described in terms of specific embodiments, but is not limited by such embodiments, and can be embodied with various modifications.

For example, although the end effector 1 of the present embodiment has five finger portions 6, the end effector 1 may have four or fewer, or six or more finger portions 6. Although the end effector 1 of the present embodiment has sixteen finger portion drive sources 15, the number of finger portion drive sources 15 is not limited to this. Although, in the present embodiment, the end effector 1 is applied to the arm of a humanoid robot, the end effector 1 may also be applied to parts of a humanoid robot other than the arm, or to robots other than humanoid robots.

In some cases, the flexible shaft 42 need not be inserted into the outer tube 43, but may instead be inserted into an outer member other than the outer tube 43. The outer member needs only to be a flexible tubular component and may be, for example, a protective member formed by the spirally winding of tape, or a tube made from a mesh structure sheet or a porous sheet. The flexible shaft 42 is protected by the outer member, into which the flexible shaft 42 is inserted, which reduces interference with the external environment, thereby enabling efficient torque transmission.

Furthermore, various changes may be made to features of the above-described embodiments such as specific configuration, position, and quantity of each component or element thereof without departing from the scope of the present invention. Moreover, part or all features of the different embodiments may be combined with each other to yield another embodiment. In the above-described embodiments, not all elements included therein are essential, and some of them may be eliminated or replaced as appropriate.

The above-described embodiments of the present invention are summarized as follows.

One aspect of the present invention provides a mechanical device (e.g., end effector 1) comprising: a first member (e.g., drive source 2); a second member (e.g., hand unit 4) connected to the first member via a joint (wrist joint 3) capable of pivoting about a first rotational axis 3X; and at least one cable (e.g., flexible shaft 42) that is flexible and supported by the first member and the second member, wherein, when a relative rotational position between the first member and the second member is a middle position within a range of rotation about the first rotational axis 3X, the at least one cable presents an S-shape between the first member and the second member as viewed along the first rotational axis 3X.

In this configuration, when the first member and the second member rotate relative to each other about the first rotational axis 3X, the cable deforms to shift its inflection point, while avoiding the cable from deforming so as to significantly change the curvature or cause large displacement of the longitudinal middle part of the cable. This prevents the cable from deforming to cause resistance to the relative rotational motions of the two members, and from coming into contact with other nearby components, thereby suppressing the increase in the resistance to relative rotational motions of the two members, which results in the improvement of efficiency of energy consumption of the mechanical device.

Preferably, the above-described device is further configured such that, when the relative rotational position between the first member and the second member is at the middle position within the range of rotation about the first rotational axis 3X, the at least one cable includes a first section 42a having a curve whose direction of curvature is a first direction, and a second section 42b having a curve whose direction of curvature is a second direction opposite to the first direction.

In this configuration, when the first member and the second member rotate relative to each other about the first rotational axis 3X, the cable deforms such that the length of one of the first and second sections becomes longer and the length of the other becomes shorter, while avoiding the cable from deforming so as to significantly change the curvature or cause large displacement of the longitudinal middle part of the cable. This prevents the cable from coming into contact with other nearby components.

Preferably, the above-described device is further configured such that a connection that connects the first section 42a to the second section 42b is positioned to intersect with the first rotational axis 3X.

In this configuration, when the first member and the second member rotate relative to each other about the first rotational axis 3X, the displacement of the cable relative to the first rotational axis 3X becomes minimal. This effectively suppresses rotational resistance caused due to contact between the cable and another cable or component.

Preferably, the above-described device is further configured such that the at least one cable includes a first section 42a having a curve with curvature whose principal direction is a first direction, and a second section 42b having a curve whose direction of curvature is a second direction opposite to the first direction, and wherein the at least one cable includes: a flexible shaft 42 as a first cable having the first section 42a on the first member side and the second section 42b on the second member side; and another flexible shaft 42 as a second cable having the first section 42a on the second member side and the second section 42b on the first member side.

When two cables are arranged side by side, differences may occur in the resistance to rotations of the two cables depending on the direction in which the first member and the second member rotate relative to each other. In this configuration, the first cable and the second cable are arranged to intersect with each other as viewed along the first rotational axis 3X. This suppresses differences in the rotational resistance depending on the direction of relative rotation between the first member and the second member.

Preferably, the above-described device is further configured such that the wrist joint 3 is configured to rotate about a second rotational axis 3Y extending in a different direction from an extending direction of the first rotational axis 3X, and wherein, when the relative rotational position between the first member and the second member is a middle position within a range of rotation about the second rotational axis 3Y, the at least one cable presents an S-shape between the first member and the second member as viewed along the second rotational axis 3Y.

In this configuration, in the case where the first member and second member rotate relative to each other about the second rotational axis 3Y as well, the cable deforms to shift their inflection points, while avoiding large displacement of the cable. This suppresses resistance to rotational motions of the two members caused due to contact between the cable and other components.

Preferably, the above-described device is further configured such that the at least one cable includes two or more cables that are arranged in a skew positional relationship with each other between the first and second members.

In this configuration, the cables are arranged such that each cable presents an S-shape in both the axial views of the first rotational axis 3X and the second rotational axis 3Y. This facilitates placement of the cables.

Preferably, the above-described device is further configured such that the at least one cable is a power transmission cable and is covered by an outer member.

When numerous cables are arranged and the first member and the second member rotate relative to each other, the cables may come into contact with each other. Furthermore, when the cables are power transmission cables, contact between the cables affects the transmitted power. In this configuration, when the first member and the second member rotate relative to each other, the cables do not come into contact with each other. Thus, the driving forces transmitted by the cables are not affected by contact between the cables.

Preferably, the above-described device is further configured such that the power transmission cable is a flexible shaft 42 that transmits torque, and the outer member is an outer tube 43 that houses the flexible shaft 42 and a lubricant.

In this configuration, the flexible shaft 42 can rotate with low resistance inside the outer tube 43, enabling efficient torque transmission.

Preferably, the above-described device is further configured such that the outer tube 43 is formed of a porous material.

In this configuration, the lubricant within the outer tube 43 seeps out onto the outer surface of the outer tube 43, which allows the outer tube 43 to slide with minimal resistance when the outer tube 43 contacts and slides against other external components.

Preferably, the above-described device is further configured such that the outer member is slidably supported by at least one of the first member and the second member so as to be movable along an extending direction of the outer member.

When the lengths of the power transmission cable and the outer member change due to differences in thermal expansion coefficients, this configuration prevents contact between the power transmission cable, which is arranged to present an S-shape, and the inner surface of the outer member. This suppresses the increase in the resistance to the motions of the power transmission cable during thermal expansion.

Preferably, the above-described device is further configured such that the first member is a drive source 2, wherein the second member is a hand unit 4, the hand unit 4 including a palm portion 5 supported by the drive source 2 via the joint, and one or more finger portions 6 movably supported by the palm portion 5, and wherein the mechanical device constitutes an end effector 1.

This configuration can provide the end effector 1 that enables the cables to be placed so as not to hinder relative rotation of the drive source 2 and the hand unit 4.

Other forms of the above-described embodiments of the present invention are as follows:

Another aspect of the present invention provides a robotic hand having an end effector 1 and a hand unit 4, the robotic hand comprising: a palm portion 5 movably supported via a wrist joint 3; a first finger portion 6A movably supported on the palm portion 5; a finger portion drive mechanism 14 provided on the palm portion 5 as a first drive mechanism for driving the first finger portion 6A; and a flexible shaft 42 as a first power transmission member having flexibility, which extends from the drive source 2 through the wrist joint 3 to be connected to the first drive mechanism and transmits driving force for the first finger portion 6A, wherein the first power transmission member passes from the wrist joint 3 through the palm portion 5 and is connected to the first drive mechanism.

In this configuration, the first power transmission member passes from the wrist joint 3 through the palm portion 5 to be connected to the first drive mechanism, thereby suppressing the increase in the size of the hand unit 4. This configuration also prevents interference between the first power transmission member and the drive source during rotation of the hand unit 4 (when the wrist joint 3 is driven).

Preferably, the above-described robotic hand is further configured such that the first power transmission member connects to the side of the first drive mechanism opposite to the wrist joint 3.

This configuration suppresses the increase in the size of the hand unit 4 even when the first power transmission member extends from the first drive mechanism of the first finger portion 6A toward the side of connection between the first power transmission member and the first drive mechanism.

Preferably, the above-described robotic hand further comprises: a second finger portion 6B and a third finger portion 6C as a plurality of finger portions supported on the side opposite the wrist joint 3 of the palm portion 5; two finger portion drive mechanisms 14 as a plurality of second drive mechanisms provided on the palm portion 5 for driving the second finger portions 6B and third finger portions 6C; and two flexible shafts 42 as a plurality of second power transmission members having flexibility, which are connected from the drive source 2 through the wrist joint 3 to the second drive mechanisms and transmit driving force to the second finger portions 6B and third finger portions 6C, wherein the first power transmission member passes between the two adjacent second drive mechanisms in the palm portion 5.

This configuration prevents the first power transmission member from protruding outward beyond the second drive mechanism over the palm portion 5, which suppresses the increase in the size of the robotic hand.

Preferably, the above-described robotic hand is further configured such that the first drive mechanism is arranged on one side of the palm portion 5, and the plurality of second drive mechanisms are arranged on the opposite side of the palm portion 5, and the first power transmission member extends to make a U-turn around the distal end of the palm portion 5 between the connection to the first drive mechanism and a position between the two second drive mechanisms.

In this configuration, the length of the first power transmission member extending on the side where the first drive mechanism of the palm portion 5 is provided becomes shorter, thereby suppressing the first power transmission member from interfering with the motion of the robotic hand.

Preferably, the above-described robotic hand is further configured such that the first power transmission member is a flexible shaft 42 that transmits torque and is inserted into an outer member such as an outer tube 43.

In this configuration, the flexible shaft 42 is protected by the outer member, which enables efficient torque transmission.

Preferably, the above-described robotic hand is further configured such that the outer member is an outer tube 43 that houses the flexible shaft and a lubricant.

This configuration enables further efficient transmission by the flexible shaft 42.

Preferably, the above-described robotic hand is further configured such that the first drive mechanism includes a screw shaft 56, a slider 57 threadedly engaged with the screw shaft 56, and a rod 58 driven by the slider 57, wherein the first power transmission member is connected to the side of the wrist joint 3 opposite the screw shaft 56.

In this configuration, the torque transmitted to the first drive mechanism is converted into linear motion of the slider 57, thereby driving the first finger portion 6A via the rod 58.

1. A mechanical device comprising:
a first member;
a second member connected to the first member via a joint capable of pivoting about a first rotational axis; and
at least one cable that is flexible and supported by the first member and the second member,
wherein, when a relative rotational position between the first member and the second member is a middle position within a range of rotation about the first rotational axis, the at least one cable presents an S-shape between the first member and the second member as viewed along the first rotational axis.

2. The mechanical device as claimed in claim 1, wherein, when the relative rotational position between the first member and the second member is at the middle position within the range of rotation about the first rotational axis, the at least one cable includes a first section having a curve whose direction of curvature is a first direction, and a second section having a curve whose direction of curvature is a second direction opposite to the first direction.

3. The mechanical device as claimed in claim 2, wherein a connection that connects the first section to the second section is positioned to intersect with the first rotational axis.

4. The mechanical device as claimed in claim 1, wherein the at least one cable includes a first section having a curve whose direction of curvature is a first direction, and a second section having a curve whose direction of curvature is a second direction opposite to the first direction, and
wherein the at least one cable includes:
a first cable having the first section on the first member side and the second section on the second member side; and
a second cable having the first section on the second member side and the second section on the first member side.

5. The mechanical device as claimed in claim 1, wherein the joint is configured to rotate about a second rotational axis extending in a different direction from a direction in which the first rotational axis extends, and
wherein, when the relative rotational position between the first member and the second member is a middle position within a range of rotation about the second rotational axis, the at least one cable presents an S-shape between the first member and the second member as viewed along the second rotational axis.

6. The mechanical device as claimed in claim 5, wherein the at least one cable includes two or more cables that are arranged in a skew positional relationship with each other between the first and second members.

7. The mechanical device as claimed in claim 1, wherein the at least one cable is a power transmission cable and is covered by an outer member.

8. The mechanical device as claimed in claim 7, wherein the power transmission cable is a flexible shaft that transmits torque, and the outer member is an outer tube that houses the flexible shaft and a lubricant.

9. The mechanical device as claimed in claim 8, wherein the outer tube is formed of a porous material.

10. The mechanical device as claimed in claim 7, wherein the outer member is slidably supported by at least one of the first member and the second member so as to be movable along an extending direction of the outer member.

11. The mechanical device as claimed in claim 1, wherein the first member is a drive source,
wherein the second member is a hand unit, the hand unit including a palm portion supported by the drive source via the joint, and one or more finger portions movably supported by the palm portion, and
wherein the mechanical device constitutes an end effector.
